(19) United States
(12) Patent Application Publication
(10) Pub. No.: US 2014/0007226 A1
(43) Pub. Date: Jan. 2, 2014

(54) ELECTRIC APPARATUS, AUTHENTICATION DEVICE AND AUTHENTICATION METHOD

(71) Applicant: KABUSHIKI KAISHA TOSHIBA, Tokyo (JP)

(72) Inventor: Masayuki Inoue, Kawasaki-shi (JP)

(73) Assignee: KABUSHIKI KAISHA TOSHIBA, Tokyo (JP)

(21) Appl. No.: 13/787,159

(22) Filed: Mar. 6, 2013

(30) Foreign Application Priority Data
Jun. 29, 2012 (JP) 2012-147410

(51) Int. Cl. G06F 21/34

(52) U.S. Cl. CPC G06F 21/34
USPC 726/19

(57) ABSTRACT

According to one embodiment, an electronic apparatus includes a first recorder, a second recorder, and a first authenticator. The first recorder is configured to record first authentication data. The second recorder is configured to record schedule data indicative of a time duration in which a first authentication process is executable. The first authenticator is configured to execute the first authentication process within the time duration in order to determine whether the second authentication data is authentic, based on the first authentication data.

### CROSS-REFERENCE TO RELATED APPLICATIONS

This application is based upon and claims the benefit of priority from Japanese Patent Application No. 2012-147410, filed Jun. 29, 2012, the entire contents of which are incorporated herein by reference.

### FIELD

Embodiments described herein relate generally to an electric apparatus, an authentication device and an authentication method for executing an authentication process for confirming a user.

### BACKGROUND

An electronic apparatus, such as a personal computer, is equipped with a function of executing an authentication process for confirming a user. For example, when a BIOS (Basic Input Output system) password has been set, the personal computer displays an input request message for a password at a time of power-on, and executes an authentication process for a password which is input. The personal computer boots up the system when the input of an authentic password has been confirmed.

In addition, there is known a personal computer having an alternative authentication function in which data for authentication, which is recorded in an external device such as a USB (Universal Serial Bus) memory, is input when a BIOS password is authenticated, and an authentication process is executed based on this data for authentication. In the alternative authentication function, by attaching the external device to the personal computer, there is no need to input the password each time power is turned on, thus enhancing the convenience for the user.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary block diagram illustrating the system configuration of a personal computer according to an embodiment.

FIG. 2 is an exemplary block diagram illustrating the configuration of a USB memory which is used for alternative authentication in the embodiment.

FIG. 3 is an exemplary flowchart illustrating a schedule setup process in the embodiment.

FIG. 4 is a view illustrating an example of a schedule setup screen in the embodiment.

FIG. 5 is a view illustrating an example of a schedule setup screen in the embodiment.

FIG. 6 is a view illustrating an example of a schedule which is indicated by alternative authentication schedule data in the embodiment.

FIG. 7 is an exemplary flowchart illustrating a system boot process at a time of power-on in the embodiment.

FIG. 8 is a view illustrating an example of update of the alternative authentication schedule data in the embodiment.

FIG. 9 is an exemplary flowchart illustrating an OS boot process in the embodiment.

FIG. 10 is an exemplary block diagram illustrating the configuration of a USB memory in the embodiment.

### DETAILED DESCRIPTION

Various embodiments will be described hereinafter with reference to the accompanying drawings.

In general, according to one embodiment, an electronic apparatus includes a first recorder, a second recorder, and a first authenticator. The first recorder is configured to record first authentication data. The second recorder is configured to record schedule data indicative of a time duration in which a first authentication process is executable. The first authenticator is configured to execute the first authentication process within the time duration in order to determine whether the second authentication data is authentic, based on the first authentication data.

It is assumed that an electronic apparatus according to an embodiment is realized, for example, as a notebook-type or a tablet-type personal computer 10. The electronic apparatus is not limited to the personal computer 10, and may be other various devices which execute authentication processes for confirming users.

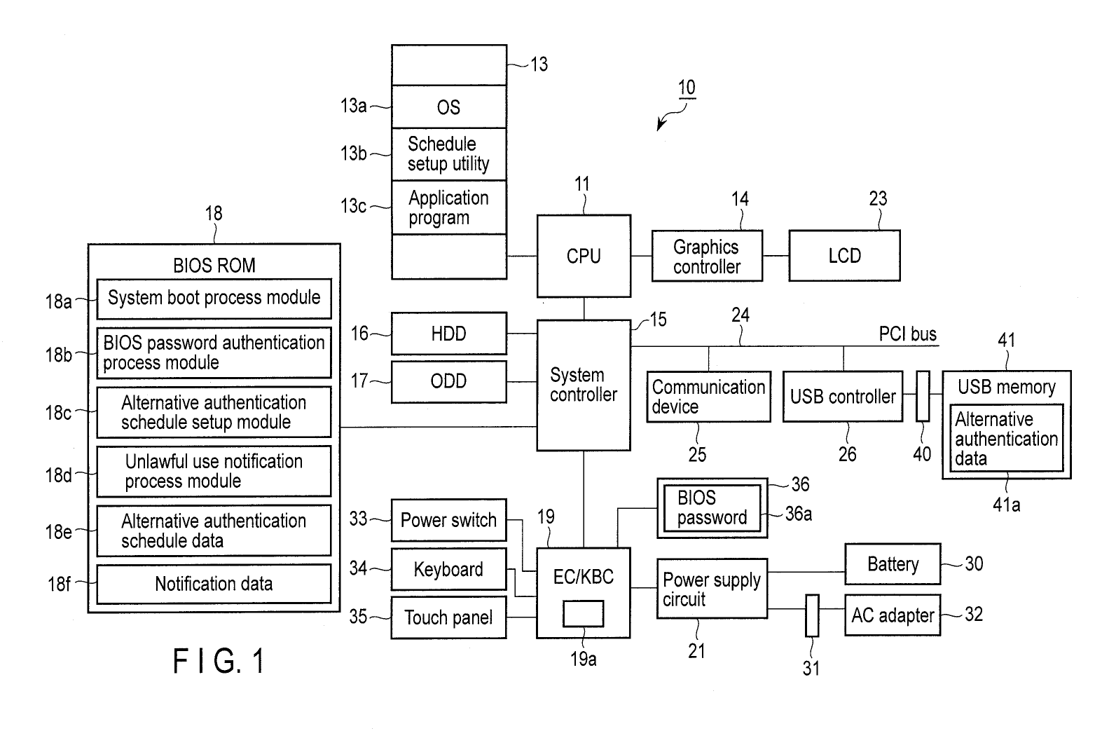

FIG. 1 illustrates the system configuration of the personal computer 10 according to the embodiment. The personal computer 10 includes a CPU 11, a main memory 13, a graphics controller 14, a system controller 15, a hard disk drive (HDD) 16, an optical disc drive (ODD) 17, a BIOS-ROM 18, and an embedded controller/keyboard controller (EC/KBC) 19.

The CPU 11 is a processor which controls the operations of the respective components of the personal computer 10. The CPU 11 executes a BIOS (Basic Input Output System), which is recorded in the BIOS-ROM 18, at a time of power-on. The BIOS includes programs (modules) relating to system boot and BIOS password authentication. In addition, the CPU 11 executes various programs which are loaded from the HDD 16 into the main memory 13, for instance, an operating system (OS) 13a, various utility programs, and various application programs.

The OS 13a in this embodiment includes a function of executing an authentication process for a login password which is input, the login password being set in advance. This function requests an input of the password at a time of startup, and executes the authentication process for the input password. In addition, the OS 13a can temporarily stop the operation of the personal computer 10 by setting the personal computer 10 in a standby state (hibernation) or in a suspend state. When restoring the personal computer 10 from the temporarily stopped state, the OS 13a can request an input of the password, in the same manner as at the time of startup, and can execute the authentication process for the input password.

The utility programs include a schedule setup utility 13b for setting schedule data indicative of a time in which the authentication process which is executed by the personal computer 10 is permitted. The schedule setup utility 13b executes a schedule setup process, and creates schedule data in accordance with an instruction from a user.

The application programs includes, in addition to various applications which are executed by the personal computer 10 alone, and an application which is realized in order to use various services which are provided via networks. The various services which are provided via networks include, for example, a cloud service. Authentication data, such as a password, is set in advance, and thereby an authentication process can be executed by the password being input, when the various applications programs are executed.

The graphics controller 14 is a display controller which controls an LCD 23 which is used as a display monitor of the personal computer 10.

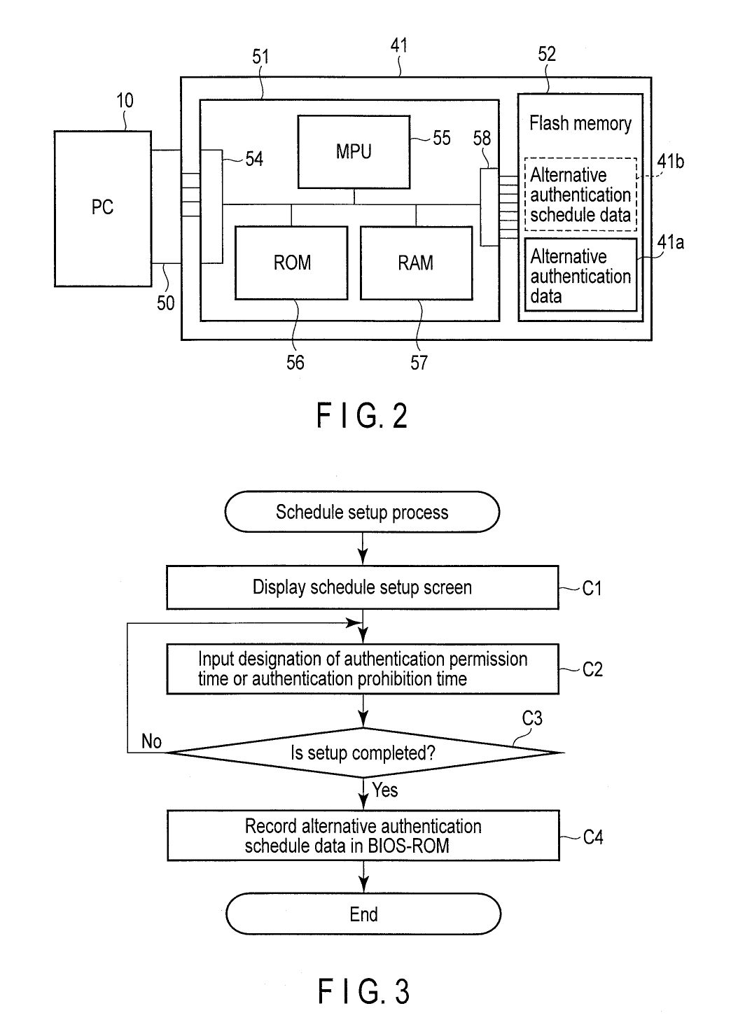

The system controller 15 is connected to a PCI bus, and communicates with devices on the PCI bus 24. For example, a communication device 25 and a USB (Universal Serial Bus) controller 26 are connected to the PCI bus 24. The communication device 25 controls communication with an external device via a network (wired or wireless). The USB controller 26 controls a USB memory 41 which is connected via a connector 40. In the present embodiment, the USB memory 41 is used for alternative authentication of a BIOS password. Alternative authentication data 41a for use in alternative authentication, which corresponds to the BIOS password that is set in the personal computer 10, is recorded in the USB memory 41. The details of the USB memory 41 will be described later (see FIG. 2). In addition, the system controller 15 includes a controller for controlling the hard disk drive (HDD) 16 and optical disc drive (ODD) 17.

The BIOS-ROM 18 stores a BIOS which is a system program for hardware control. When BIOS setup has been requested by a predetermined operation (e.g. pressing of a function key) at a time of startup, the CPU 11 displays a BIOS setup screen and executes setup for hardware control. In the BIOS setup, a BIOS password can be set. The BIOS password is recorded in a memory 36 which is treated as a hidden area that is connected to the EC/KBC 19.

In addition, the BIOS-ROM 18 includes, for example, a system boot process module 18a, a BIOS password authentication process module 18b, an alternative authentication schedule setup module 18c, an unlawful use notification process module 18d, an alternative authentication schedule data 18e, and notification data 18f.

The system boot process module 18a is a module for executing a startup process at a time of power-on, and executing, for example, a process of initializing various devices.

The BIOS password authentication process module 18b is a module for executing BIOS password authentication at a time of power-on. The BIOS password authentication process module 18b sends to the EC/KBC 19 a password which has been input by an operation of the keyboard 34, or the alternative authentication data 41a which has been input from the USB memory 41, and receives a determination result of the authentication process by the EC/KBC 19.

The alternative authentication schedule setup module 18c is a module for setting schedule data indicative of a time for permitting the authentication process which is executed in the personal computer 10. When schedule setup has been instructed in the BIOS setup which is started at a time of power-on, the alternative authentication schedule setup module 18c executes a schedule setup process and creates schedule data in accordance with an instruction from the user.

The unlawful use notification process module 18d is a module for a notification process of sending a notification, for example, by e-mail, to a notification destination that is preset as the notification data 18f, when an unlawful startup process has been executed, for example, when a startup process (system boot, OS boot) has been executed at a time other than the time in which the authentication process is permitted by the schedule data.

The alternative authentication schedule data 18e is data indicative of a time for permitting the authentication process, and is created by the schedule setup utility 13b or alternative authentication schedule setup module 18c.

The notification data 18f includes data indicative of a notification destination (e.g. e-mail address) and data indicative of a notification message (e.g. text data), which are used in the notification process by the unlawful use notification process module 18d. The notification data 18f is created by the schedule setup utility 13b or alternative authentication schedule setup module 18c.

The EC/KBC 19 is connected to the system controller 15. The EC/KBC 19 is realized as a one-chip microcomputer including a power management controller for executing power management of the personal computer 10, and a keyboard controller for controlling the keyboard 34 and a touch panel 35. In addition, the EC/KBC 19 has a function of powering on/off the personal computer 10 in accordance with the user's operation of a power switch 33.

Besides, the memory 36, which is treated as a hidden area, is connected to the EC/KBC 19. The EC/KBC 19 records in the memory 36 a BIOS password which is set by BIOS setup. The EC/KBC 19 includes an authentication module 19a. Upon receiving an authentication request for an input password, the authentication module 19a refers to the BIOS password 36a, determines whether the input password is authentic, and sends a determination result to the CPU 11.

A power supply circuit 21 generates power (operation power) which is to be supplied to the respective components, by using power from a battery 30 that is mounted in the main body of the personal computer 10, or power from an AC adapter 32 that is connected via a connector 31 to the main body of the personal computer 10 as an external power supply. When the AC adapter 32 is connected, the power supply circuit 21 generates the operation power to the respective components by using the power from the AC adapter 32, and charges the battery 30 by a charging circuit (not shown).

FIG. 2 is an exemplary block diagram illustrating the configuration of the USB memory 41 which is used for alternative authentication in the embodiment.

As shown in FIG. 2, the USB memory 41 includes a USB connector 50, a controller 51, and a flash memory 52. The USB connector 50 functions as a connection terminal for connection to a USB connector which is provided on the personal computer 10.

The controller 51 includes a USB interface 54, an MPU 55, a ROM 56, a RAM 57, and a memory interface 58. The USB interface 54 receives, via the USB connector 50, data or commands which are transmitted from the personal computer 10. In addition, the USB interface 54 transmits data, which is read out of the flash memory 52 and input via the memory interface 58, to the personal computer 10 via the USB connector 50. In the flash memory 52, for example, the alternative authentication data 41a is recorded, and the alternative authentication data 41a is read out at a time of the alternative authentication process of the personal computer 10.

The MPU 55 processes commands which are received from the personal computer 10, and data which is read out of the flash memory 52, by using the ROM 56 and RAM 57. The ROM 56 stores programs and data which are necessary for processes in the MPU 55. The RAM 57 is used as a working area in the process of the MPU 55. The memory interface 58 is connected to the flash memory 52, and transfers commands and data, which have been received by the USB interface 54, to the flash memory 52 in accordance with an instruction of the MPU 55. In addition, the memory interface 58 transfers data, which has been read out of the flash memory 52, to the USB interface 54.

In the flash memory 52, data is recorded by the control of the MPU 55. When the USB memory 41 is used as an external device (token) of alternative authentication which is executed in the personal computer 10, the alternative authentication data 41a is recorded in advance, for example, by a work of a system administrator or the like, who is different from the user of the personal computer 10. The alternative authentication data 41a is read out, responding to a request from the personal computer 10.

In the above description, the USB memory 41 is used for alternative authentication. Alternatively, it is possible to use some other external device in which a memory that records the alternative authentication data 41a is mounted. In addition, the external device may be configured to be provided with an input module for inputting data that is used as the alternative authentication data (e.g. an input module for inputting biological information such as a fingerprint).

Next, the operation of the personal computer 10 in the embodiment is described.

In the personal computer 10 in this embodiment, a BIOS password is set in the BIOS setup. Thereby, the BIOS password authentication is executed at a time of power-on. At the time of power-on, if the USB memory 41, in which the alternative authentication data 41a is recorded in advance, is attached to the connector 40, the personal computer 10 reads out the authentication data 41a from the USB memory 41 and executes alternative authentication. Thus, by attaching the USB memory 41 at the time of power-on, there is no need to input a password by operating the keyboard 34 for the purpose of BIOS password authentication, thus enhancing the convenience for the user. In addition, in the personal computer 10 in the embodiment, by presetting schedule data indicative of a time in which an authentication process is permitted, it is possible to prohibit execution of alternative authentication at times other than the time for permitting the authentication process. Thereby, even if a person, other than the authentic user of the USB memory 41, takes possession of the USB memory 41, it is possible to prevent the personal computer 10 from being started up at times other than the time for permitting the authentication process.

Next, referring to a flowchart illustrated in FIG. 3, a description is given of a schedule setup process for setting schedule data.

The schedule setup process in the embodiment may be realized by a first setup method which is executed by the alternative authentication schedule setup module 18c as one function of the BIOS setup, and a second setup method which is executed by the schedule setup utility 13b.

To begin with, the first method is described.

If setup of schedule data has been instructed in the BIOS setup, the CPU 11 executes the alternative authentication schedule setup module 18c and starts the schedule setup process. The CPU 11 causes the LCD 23 to display a schedule setup screen via the graphics controller 14 (block C1). The CPU 11 inputs designation of an alternative authentication permission time or an alternative authentication prohibition time through the schedule setup screen (block C2).

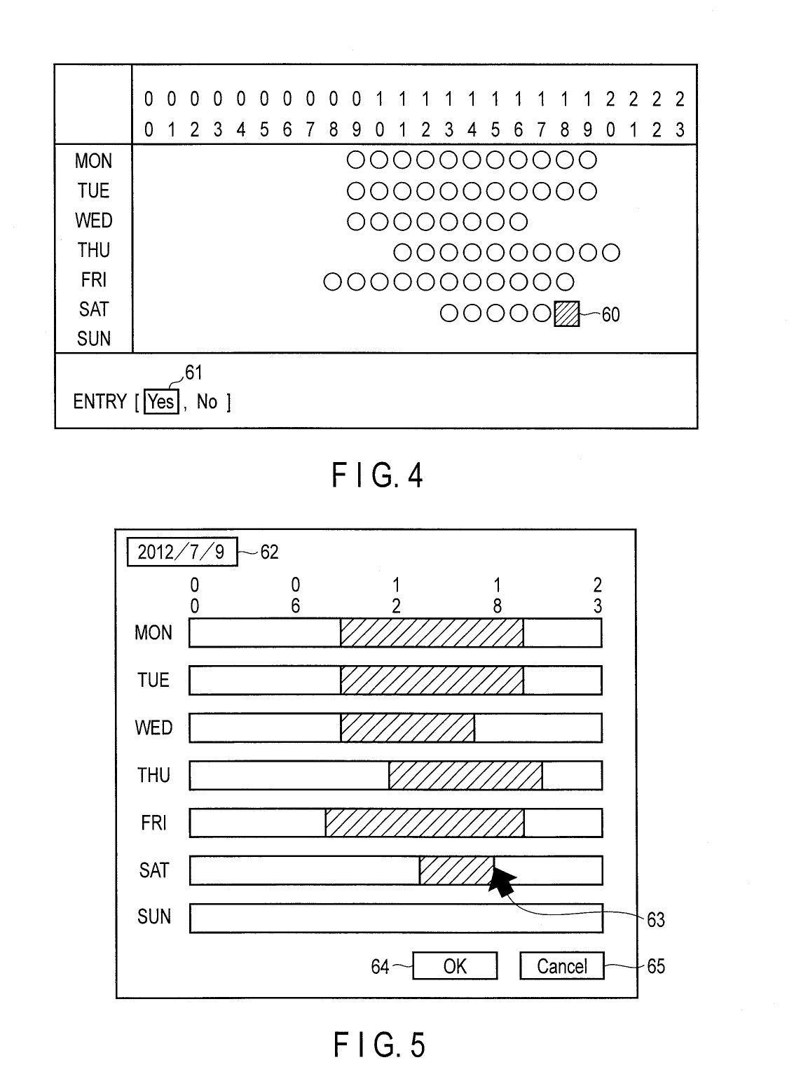

FIG. 4 is a view illustrating an example of the schedule setup screen which is displayed by the alternative authentication schedule setup module 18c. In the schedule setup screen shown in FIG. 4, a schedule of 24 hours (“00” to “23”) can be designated with respect each day (Monday to Saturday) of one week. On the schedule setup screen, a cursor 60, whose display position moves, for example, in accordance with an operation of a cursor key of the keyboard 34, is displayed. If a predetermined key of the keyboard 34 is pressed, “o” mark is displayed at a position where the cursor 60 is displayed. It is indicated that a time, at which “o” mark is displayed, has been set as a BIOS password alternative authentication permission time. In addition, if a predetermined key of the keyboard 34 is pressed in the state in which the cursor 60 is set a position where “o” mark is displayed, the CPU 11 deletes the “o” mark at the position of the cursor 60. It is indicated that a time, at which “o” mark is not displayed, has been set as a BIOS password alternative authentication prohibition time.

If a cursor 61 is moved to the position of “YES” in an “ENTRY” field displayed on the schedule setup screen and an “enter” key on the keyboard 34 is pressed, the CPU 11 determines that the setup of the schedule has been completed (Yes in block C3), and generates alternative authentication schedule data 18e in accordance with the setup content on the schedule setup screen and records the alternative authentication schedule data 18e in the BIOS-ROM 18 (block C4).

Next, the second method is described. The second method is executed by the procedure illustrated in the flowchart of FIG. 3 in the same manner as in the first method, so a detailed description is omitted.

FIG. 5 is a view illustrating an example of a schedule setup screen which is displayed by the schedule setup utility 13b. In the schedule setup screen shown in FIG. 5, a schedule of 24 hours (“00” to “23”) can be set with respect each day (Monday to Saturday) of one week. On the schedule setup screen, a date designation area 62 for inputting a date, which is a setup target of the schedule, is provided, and a schedule designation area of one week from a day, which is designated by the date designation area 62, is displayed. On the schedule setup screen, a cursor 63 which moves, for example, in accordance with an operation of the touch panel 35 (or a pointing device such as a mouse), is displayed.

The user performs, for example, a drag operation of the cursor 63 (an operation of moving the cursor 63 while pressing a predetermined key) in any one of schedule designation areas, thus being able to designate a dragged range as a BIOS password alternative authentication permission time. In FIG. 5, ranges indicated by hatching are BIOS password alternative authentication permission times, and other ranges are BIOS password alternative authentication prohibition times.

If an OK button 64 is designated by an operation of the cursor 63, the CPU 11 generates alternative authentication schedule data 18e in accordance with the content designated on the schedule setup screen (schedule designation area), and records the alternative authentication schedule data 18e in the BIOS-ROM 18.

In the meantime, the range designated as the BIOS password alternative authentication permission time may not only be graphically displayed, as shown in FIG. 5, but also the designated time may be displayed by numerals.

In the examples of the schedule setup screen, which are illustrated in FIG. 4 and FIG. 5, the schedule of one week can be set. Alternatively, a specific date may be designated, and a schedule may be individually set on a day-by-day basis. In addition, it is possible to execute setting as to whether the alternative authentication schedule data 18e, which has been set through the schedule setup screen, is to be continuously used, or the alternative authentication schedule data 18e of the past is to be invalidated.

Furthermore, on the schedule setup screen, it is possible to execute setting as to whether a notification process is to be executed by the unlawful use notification process module 18d. For example, when a system boot process of the personal computer 10 has been executed at the BIOS password alternative authentication prohibition time, or when alternative authentication has failed even at the BIOS password alternative authentication permission time, the notification process issues a notification, for example, by e-mail, to a notification destination that is preset as the notification data 18f. Incidentally, the notification destination (e-mail address) or message (content of mail) may be arbitrarily set by the user on the schedule setup screen.

It is assumed that the data indicative of the setup content, which indicates the presence/absence of invalidation of the schedule or the presence/absence of the execution of the notification process, is recorded in the BIOS-ROM 18.

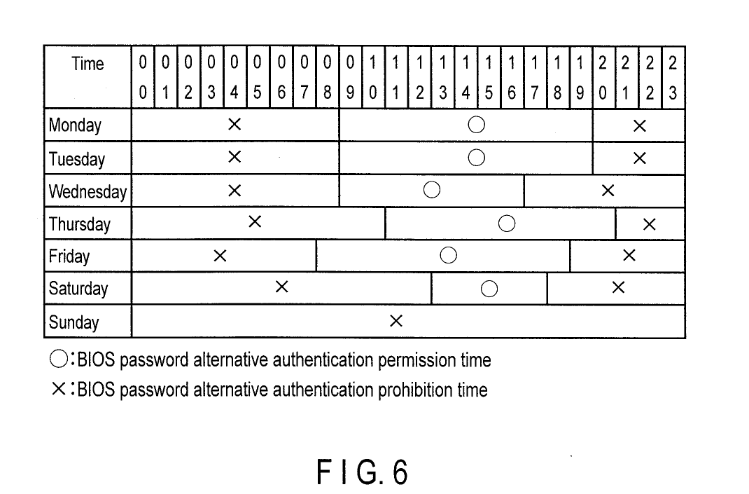

FIG. 6 is a view illustrating an example of the schedule which is indicated by the alternative authentication schedule data 18e that has been set by the schedule setup process.

In FIG. 6, a time indicated by “o” is a BIOS password alternative authentication permission time, and a time indicated by “x” is a BIOS password alternative authentication prohibition time.

For example, on Monday, the user plans to use the personal computer 10 from 9:00 to 20:00. Thus, this time is set as the BIOS password alternative authentication permission time. Since the system can be booted by alternative authentication within this time, the convenience for the user by using the alternative authentication (USB memory 41) can be secured. Within this time, since the authentic user is using the personal computer 10, even if a third person takes possession of the USB memory 41 in which the alternative authentication data 41a is recorded, it is difficult for the third person to unlawfully use the personal computer 10.

On the other hand, in the BIOS password alternative authentication prohibition time, the possibility is high that the authentic user is away from the personal computer 10. Within this time, if a third person takes possession of the USB memory 41, it is possible that the third person tries unlawful system boot of the personal computer 10 by making use of the USB 41. In the present embodiment, by presetting the alternative authentication schedule data 18e, alternative authentication is disabled in the BIOS password alternative authentication prohibition time, and system boot is prevented.

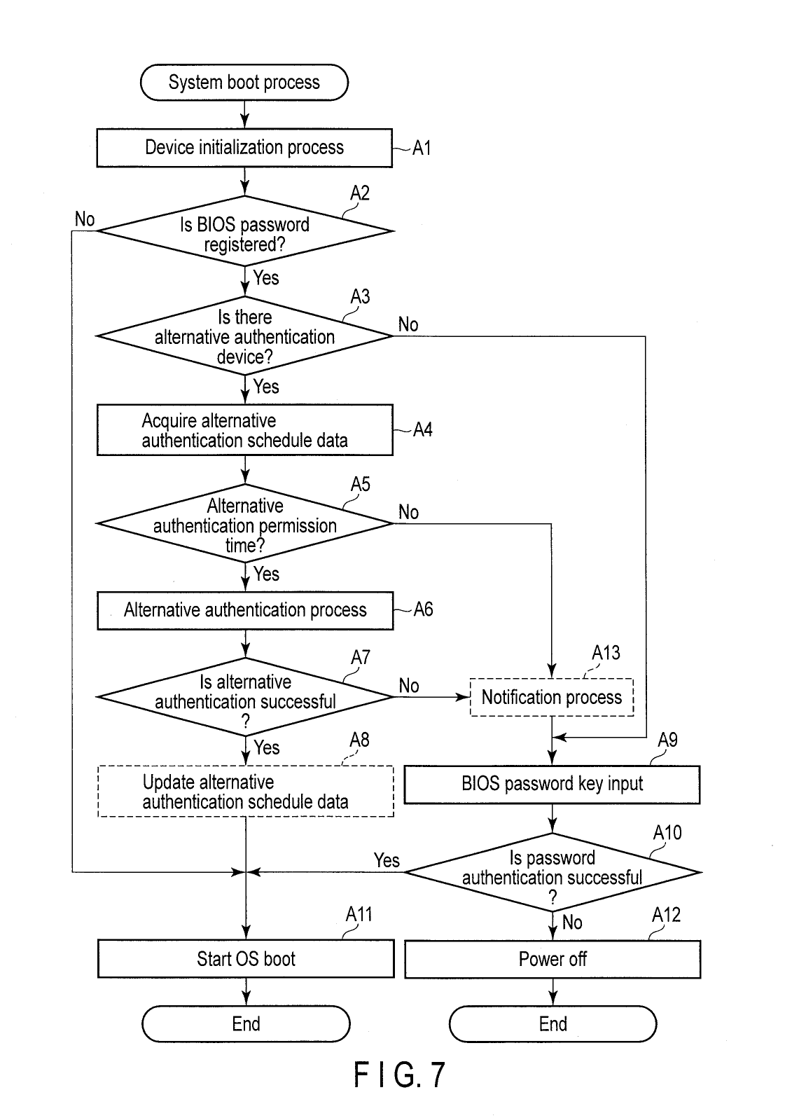

Next, referring to a flowchart of FIG. 7, a description is given of a system boot process at a time of power-on in the embodiment.

If power is turned on by an operation on the power switch 33 by the user, the CPU 11 executes an initialization process for various devices by the system boot process module 18a (block A1). For example, the initialization process renders operable the LCD 23, recording devices such as HDD 16 and ODD 17, devices such as communication device 25 and USB controller 26 which are connected via the PCI bus 24, and input devices such as keyboard 34 and touch panel 35.

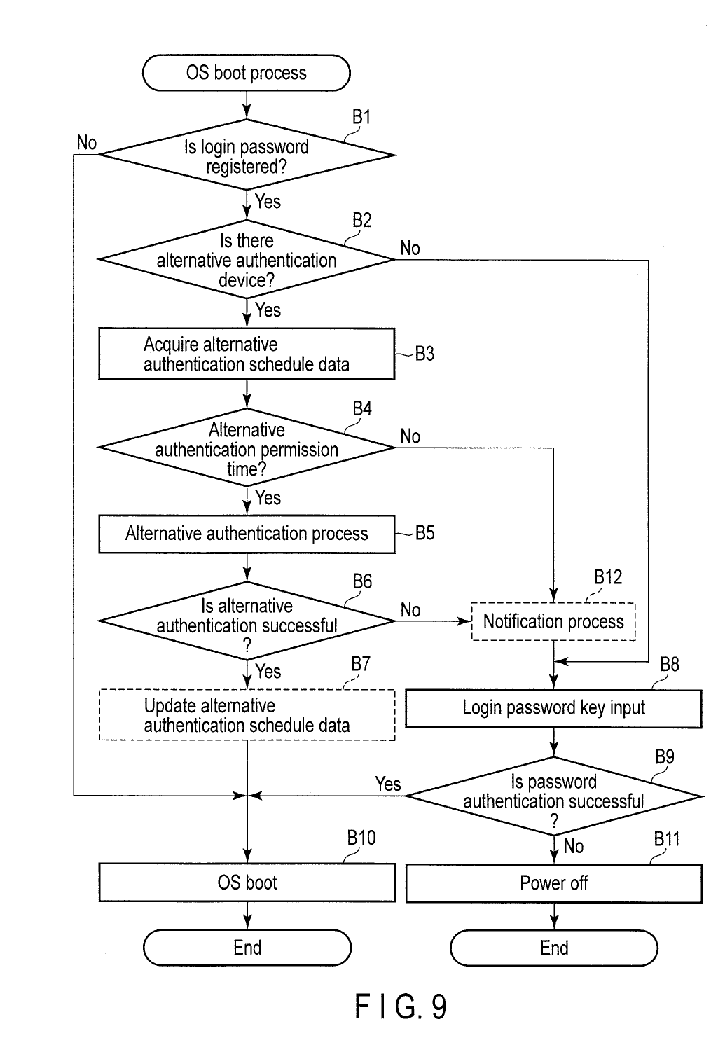

If the initialization process is completed, the CPU 11 executes a process for BIOS password authentication by the BIOS password authentication process module 18b. The CPU 11 determines whether the BIOS password 36a is recorded in the hidden area (memory 36). If the BIOS password 36a is not recorded (No in block A2), a normal boot process is executed, and the boot of the OS 13a is started (block A11). It is assumed that the boot process of the OS 13a is executed according to a flowchart of FIG. 9 which will be described later.

On the other hand, if the BIOS password 36a is recorded (Yes in block A2), the CPU 11 determines whether an external device for alternative authentication is attached to the personal computer 10. Specifically, the CPU 11 determines, through the USB controller 26, whether the USB memory 41, in which the alternative authentication data 41a is recorded, is attached or not.

If the USB memory 41 is not attached (No in block A3), the CPU 11 executes a normal BIOS password authentication. Specifically, the CPU 11 causes the LCD 23 to display a screen requesting an input of the BIOS password, and inputs the password by a key operation on the keyboard 34 (block A9). The CPU 11 sends the password, which has been input by the key operation on the keyboard 34, to the EC/KBC 19, and requests determination on the authenticity of the password.

The authentication module 19a of the EC/KBC 19 determines whether the password, which has been received from the CPU 11, is authentic or not, based on the BIOS password 36a recorded in the memory 36. The EC/KBC 19 sends the determination result by the authentication module 19a to the CPU 11.

If the EC/KBC 19 (authentication module 19a) has determined that the input password is not authentic, that is, if the password authentication has failed (No in block A10), the CPU 11 terminates the system boot process and instructs the EC/KBC 19 to turn off power (block A12). If the EC/KBC 19 (authentication module 19a) has determined that the input password is authentic, that is, if the password authentication has been successfully carried out (Yes in block A10), the CPU 11 starts the boot of the OS 13a (block A11).

On the other hand, if the USB memory 41 is attached (Yes in block A3), the CPU 11 acquires the alternative authentication schedule data 18e which is recorded in the BIOS-ROM 18, and determines whether the present time is within the BIOS password alternative authentication permission time. If it is determined that the present time is within the BIOS password alternative authentication permission time (Yes in block A5), the CPU 11 executes an alternative authentication process (block A6). Specifically, the CPU 11 inputs, through the USB controller 26, the alternative authentication data 41a which is recorded in the USB memory 41, sends the alternative authentication data 41a to the EC/KBC 19, and requests determination on the authenticity of the password.

The authentication module 19a of the EC/KBC 19 determines whether the alternative authentication data 41a, which has been received from the CPU 11, is authentic or not, based on the BIOS password 36a recorded in the memory 36. The EC/KBC 19 sends the determination result by the authentication module 19a to the CPU 11.

If the EC/KBC 19 (authentication module 19a) has determined that the alternative authentication data 41a, which has been received from the USB memory 41, is authentic, that is, if the password alternative authentication has been successfully carried out (Yes in block A7), the CPU 11 starts the boot of the OS 13a (block A11). (Step A8 in FIG. 7 will be described later.)

On the other hand, if it is determined that the present time is within the BIOS password alternative authentication prohibition time (No in block A5), the CPU 11 executes normal BIOS password authentication. Specifically, even when the USB memory 41 in which the alternative authentication data 41a is recorded is attached, if the present time is within the BIOS password alternative authentication prohibition time, the CPU 11 does not execute the alternative authentication. Therefore, even if a third person takes possession of the USB memory 41 and the third person tries to execute the system boot process by using the USB memory 41, the system cannot be booted by alternative authentication.

In the normal BIOS password authentication, the CPU 11 causes the LCD 23 to display a screen requesting an input of the BIOS password, and inputs the password by a key operation on the keyboard 34 (block A9). (Step A13 in FIG. 7 will be described later.) If the password authentication has been successfully carried out by the password that has been input by the key operation (Yes in block A10), the CPU 11 starts the boot of the OS 13a (block A11). Specifically, if the present time is within the BIOS password alternative authentication prohibition time, only the authentic user, who can input the BIOS password, can boot the system.

In the meantime, even if the present time is within the BIOS password alternative authentication permission time, if alternative authentication data 41a, which corresponds to some other personal computer, is recorded in the USB memory 41 that is attached to the connector 40, the alternative authentication fails (No in block A7). In this case, the CPU 11 executes the normal BIOS password authentication (block A9, A10).

In this manner, in the personal computer 10 in this embodiment, the alternative authentication schedule data 18e is pre-recorded in the BIOS-ROM 18. Thereby, even if the USB memory 41 in which the alternative authentication data 41a is recorded is attached, the alternative authentication is not executed within the BIOS password alternative authentication prohibition time. Thus, even if the USB memory 41 is taken possession of by a third person, the system cannot be booted by alternative authentication using the USB memory 41 within the BIOS password alternative authentication prohibition time in which the user does not intend to use the personal computer 10. Thereby, unlawful use of the personal computer 10 by the third person can be prevented.

Next, block A8 in FIG. 7 is described.

In the above-described schedule setup process, such setting is possible that the alternative authentication schedule data 18e of the past is invalidated. When the CPU 11 has executed alternative authentication for the alternative authentication data 41a, the cup 11 changes the alternative authentication schedule data 18e by the alternative authentication schedule setup module 18c. Specifically, when such setting is made that the schedule of the past is invalidated, if alternative authentication using the USB memory 41 has been successfully carried out, the CPU 11 updates the alternative authentication schedule data 18e recorded in the BIOS-ROM 18, based on the time at which the alternative authentication has been executed (block A8). For example, the BIOS password alternative authentication permission time, which precedes the time point at which the alternative authentication has been executed, is invalidated (BIOS password alternative authentication prohibition time).

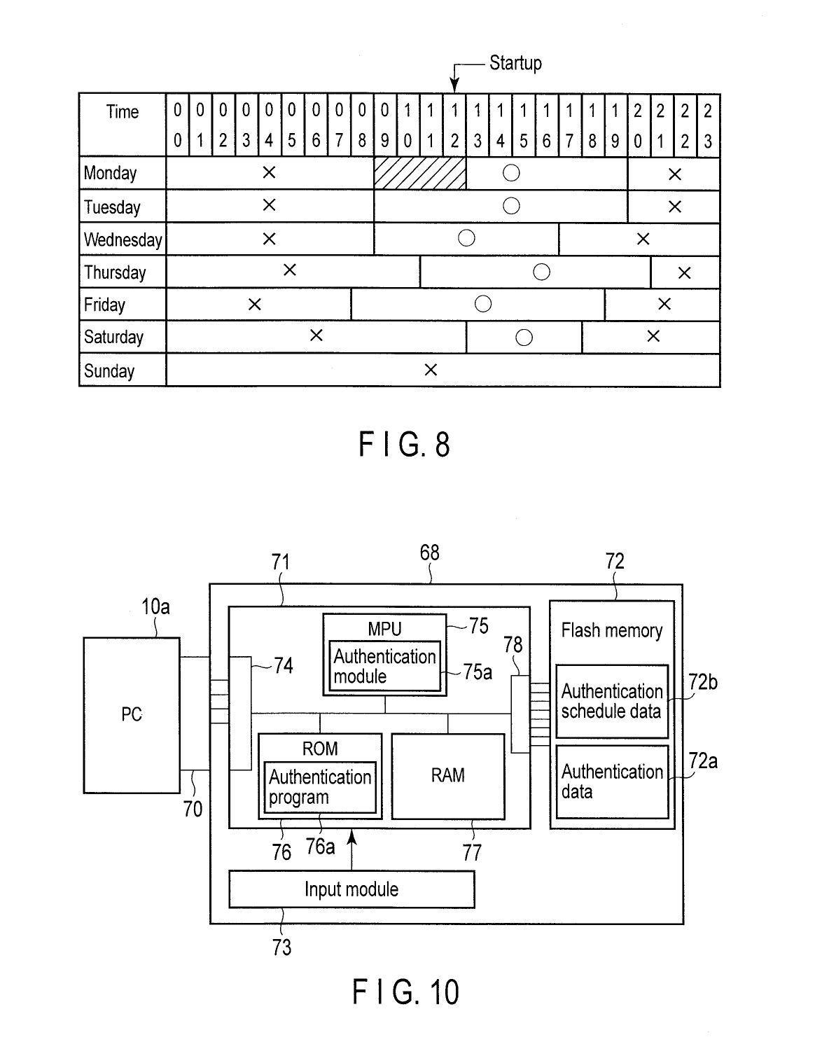

FIG. 8 is a view illustrating an example of update of the alternative authentication schedule data 18e.

It is assumed that the schedule of one week (Monday to Sunday) is set, as shown in FIG. 6, and an alternative authentication process was executed between 12:00 and 13:00 of Monday. In this case, as shown in FIG. 8, the alternative authentication schedule data 18e is updated such that the range of “09” to “12” (indicated by hatching in FIG. 8) of Monday, which was the BIOS password alternative authentication permission time, has been changed to the BIOS password alternative authentication prohibition time.

In this manner, when the alternative authentication has been executed based on the alternative authentication schedule data 18e, the schedule of the pas is invalidated. Thereby, it is possible to prevent the alternative authentication process from being controlled by using the old alternative authentication schedule data 18e. In the case where the schedule of the past is invalidated, the alternative authentication schedule data 18e of the next week is to be set again, and a proper schedule, which conforms to the user's plan of using the personal computer 10, can be created. Therefore, unlawful alternative authentication using the USB memory 41 can be made more difficult.

In the above description, each time alternative authentication is executed, the alternative authentication schedule data 18e is updated in units of an hour, based on the time point at which alternative authentication has been executed. Alternatively, the schedule of the past may be invalidated at other timings, for example, in units of a minute, in units of a day, or in units of a week. For example, if the personal computer 10 was booted on Tuesday by alternative authentication, the set schedule of Monday is invalidated. In addition, in the case where the alternative authentication schedule data 18e for a plurality of weeks can be set, the schedule is similarly invalidated in units of a week.

Next, block A13 in FIG. 7 is described.

In the above-described schedule setup process, such setting is possible that the notification process is executed. When the system boot process of the personal computer 10 was executed in the BIOS password alternative authentication prohibition time (No in block A5) or when alternative authentication failed even in the BIOS password alternative authentication permission time (No in block A7), the CPU 11 executes the notification process by the unlawful use notification process module 18d.

In the notification process, for example, an e-mail of a predetermined message is transmitted via the communication device 25 to a notification destination (e-mail address) which is set as notification data 18f. For example, by setting the e-mail address of the system administrator, the system administrator can quickly be notified that unlawful system boot was attempted on the personal computer 10.

Incidentally, by setting a plurality of notification destinations, e-mails may be transmitted to the plural notification destinations at the same time. In addition, different messages may be transmitted in the case where the system boot process was executed in the BIOS password alternative authentication prohibition time and in the case where alternative authentication failed.

Besides, in the above-described notification process, the time of execution of the system boot process or the data which identifies the USB memory 41 may be recorded as a log in the BIOS-ROM 18.

Next, referring to a flowchart of FIG. 9, a description is given of the OS boot process in the embodiment.

The above description is given of the case where BIOS password authentication is executed at a time of power-on. A description will now be given of the case where login password authentication is executed at a time of the OS boot process. The process illustrated in FIG. 9 may be executed as a function included in the OS 13a, or may be executed by a program which is added to the existing OS 13a.

The process of blocks B1 to B12 illustrated in FIG. 9 is executed basically in the same manner as the process of blocks A2 to A13 illustrated in FIG. 7, except that the target of authentication is the login password which is managed by the OS 13a. Thus, a detailed description thereof is omitted.

In the OS boot process in this embodiment, it is assumed that alternative authentication data for a login password is recorded in the external device (USB memory 41), like the alternative authentication for the BIOS password. Accordingly, it is assumed that the alternative authentication data 41a for the BIOS password and the alternative authentication data for the login password of the OS 13a are recorded in the USB memory 41. In addition, it is assumed that the alternative authentication schedule data 18e is also used in the case of determining whether or not to execute the alternative authentication of the login password. In order to determine whether or not to execute the alternative authentication of the login password, schedule data which is different from the alternative authentication schedule data 18e may be separately set.

The login password authentication is executed at a time of startup by registering the login password in advance. The OS boot process is executed in subsequent to the above-described system boot process, and is also executed at a time of restoration from the state in which the operation is temporarily stopped by hibernation or suspend.

At a time of restoration from the state in which the operation is temporarily stopped, the BIOS password authentication is not executed. However, in the OS boot process, alternative authentication can be prevented from being executed in the alternative authentication prohibition time indicated by the alternative authentication schedule data 18e. Therefore, even if the USB memory 41, in which the alternative authentication data for login password authentication is recorded, has been taken possession of by a third person, the personal computer 10 in the state in which the operation is temporarily stopped can be prevented from being unlawfully started up.

The above description is given of the case of executing the login password authentication at the time of the OS boot process. However, the above description is applicable to password authentication at a time of executing an application program. For example, by presetting authentication data such as a password, an authentication process is executed by inputting the password when various applications are executed (e.g. at a time of using cloud services). In this case, like the above-described case, alternative authentication of the password using the external device (USB memory 41) can be executed, and alternative authentication can be executed only in the alternative authentication permission time by preset schedule data. Thereby, it is possible to avoid unlawful execution of an application with use of the personal computer 10.

Next, a modification of the USB memory 41, which is used for alternative authentication, is described.

In the above description, the alternative authentication schedule data 18e is recorded in the BIOS-ROM 18. However, as shown in FIG. 2, alternative authentication schedule data 41b, in place of the alternative authentication schedule data 18e, may be recorded in the USB memory 41. In this case, it is assumed that the alternative authentication schedule data 41b has such a format that the schedule cannot be rewritten even if a third person takes possession of the USB memory 41. When the schedule setup utility 13b has been executed in the personal computer 10 and a change of the alternative authentication schedule data 41b has been instructed, the USB memory 41 (MPU 55) changes the alternative authentication schedule data 41b in accordance with this instruction.

In addition, use may be made of an external device (USB memory 68) having a configuration illustrated in FIG. 10. The USB memory 68 shown in FIG. 10 includes a USB connector 70, a controller 71, a flash memory 72 and an input module 73. Further, the controller 71 includes a USB interface 74, an MPU 75, a ROM 76, a RAM 77 and a memory interface 78. The USB memory 68 has basically the same configuration as the USB memory 41 shown in FIG. 2, and a detailed description thereof is omitted.

In the above description, the alternative authentication data 41a is recorded in advance in the USB memory 41. When the USB memory 68 is used, data which is input from the input module 73 is used as alternative authentication data. The input module 73 is a sensor for inputting, for example, biological information. The input module 73 scans, for example, a fingerprint as biological information, and inputs data of a fingerprint pattern. The USB memory 68 outputs the data of the fingerprint pattern as alternative authentication data to the personal computer 10.

Incidentally, the USB memory 68 may input biological information other than the fingerprint pattern. For example, there may be provided an input module 73 configured to input an iris pattern, a palm print or a vein pattern.

In addition, in the USB memory 68, the alternative authentication data is input so that the USB memory 68 may be used as an external device for alternative authentication. In order to activate a function which is provided in the USB memory 68, authentication data may be input from the input module 73. In this case, for example, as shown in FIG. 10, it is assumed that authentication data 72a is recorded in the flash memory 72. It is assumed that the authentication data 72a is generated, for example, based on data which is input in advance from the input module 73 by the authentic user. Besides, in the flash memory 72, authentication schedule data 72b is recorded by, for example, a utility program which is executed in a personal computer 10a. It is assumed that the authentication schedule data 72b, like the above-described alternative authentication schedule data 18e, is data indicative of an authentication process permission time, and has such a format that the schedule cannot be rewritten even if a third person takes possession of the USB memory 68.

The MPU 75 realizes an authentication module 75a which executes an authentication process for data that is input from the input module 73, by executing an authentication program 76a which is recorded in the ROM 76.

If data such as biological information is input by the input module 73, the authentication module 75a determines whether the present time is the authentication process permission time, by referring to the authentication schedule data 72b. When it is determined that the present time is not the authentication process permission time, the authentication module 75a does not execute the authentication process for the data which has been input from the input module 73. Thus, the function provided in the USB memory 68 is not executed. On the other hand, if the present time is the authentication process permission time, the authentication module 75a executes, based on the authentication data 72a, the authentication process for the input data. When the input data has been determined to be authentic data, the authentication module 75a activates the function provided in the USB memory 68. Of course, if the authentication process failed, the authentication module 75a does not activate the function provided in the USB memory 68.

In this manner, since the authentication process is executed only in the authentication process permission time indicated by the authentication schedule data 72b, the use of the function provided in the USB memory 68 can be restricted. For example, if only the system administrator can execute the utility program for setting the authentication schedule data 72b, even the authentic user of the USB memory 68 can use the USB memory 68 only in the authentication process permission time that was set by the system administrator.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic apparatus comprising:
a first recorder configured to record first authentication data;
a second recorder configured to record schedule data indicative of a time duration in which a first authentication process is executable; and
a first authenticator configured to execute the first authentication process within the time duration in order to determine whether a second authentication data is authentic, based on the first authentication data.

2. The electronic apparatus of claim 1, further comprising a schedule setter configured to create the schedule data.

3. The electronic apparatus of claim 1, wherein the second authentication data is inputted from an external device.

4. The electronic apparatus of claim 3, wherein third authentication data is inputted when the second authentication data is not authentic, and
the first authenticator is configured to execute a second authentication process for determining whether the third authentication data is authentic, based on the first authentication data.

5. The electronic apparatus of claim 1, further comprising an updater configured to update the schedule data when the first authentication process is executed.

6. The electronic apparatus of claim 1, wherein
fourth authentication data is inputted after the first authentication process; and
a second authenticator configured to execute a third authentication process within the time duration in order to determine whether the fourth authentication data is authentic.

7. The electronic apparatus of claim 1, further comprising a notifier configured to send a notification to a first notification destination, when the first authentication process is executed.

8. An authentication device comprising:
a connector configured to be connected to an electronic apparatus;
a first storage configured to store authentication data which is referred to in an authentication process by the electronic apparatus; and
a second storage configured to store schedule data indicative of a time duration in which the authentication process is executable.

9. The authentication device of claim 8, further comprising an updater configured to update the schedule data in accordance with an instruction from the electronic apparatus.

10. An authentication method comprising:
recording first authentication data;
recording schedule data indicative of a time duration in which an authentication process is executable;
inputting second authentication data; and
determining whether the second authentication data is authentic within the time duration, based on the first authentication data.
